(19) United States
(12) Patent Application Publication
(10) Pub. No.: US 2012/0009496 A1
(43) Pub. Date: Jan. 12, 2012

(54) FUEL CELL SEPARATOR MATERIAL, FUEL CELL SEPARATOR USING SAME, FUEL CELL STACK, AND METHOD FOR PRODUCING FUEL CELL SEPARATOR MATERIAL

(75) Inventor: Yoshitaka Shibuya, Ibaraki (JP)

(73) Assignee: JX Nippon Mining & Metals Corporation, Tokyo (JP)

(21) Appl. No.: 13/139,237

(22) PCT Filed: Dec. 10, 2009
(86) PCT No.: PCT/JP2009/070648

§ 371 Date: Sep. 21, 2011

(30) Foreign Application Priority Data
Dec. 19, 2008 (JP) 2008-323513

(51) Int. Cl. H01M 8/04; B05D 5/12; H01M 2/16; H01M 8/24; B82Y 30/00

(52) U.S. Cl. 429/455; 429/513; 429/516; 429/452; 427/115; 977/755

(57) ABSTRACT

A fuel cell separator material, comprising an alloy layer 6 containing Au and a first component containing Al, Cr, Co, Ni, Cu, Mo, Sn or Bi, or an Au single layer 8 formed on a stainless steel base 2, and an intermediate layer 2a containing 20 mass % or more of the first component, and from 20 mass % or more to less than 50 mass % of arranged between the alloy layer and the base, wherein the alloy layer has a region having a thickness of 1 nm or more from the uppermost surface toward the lower layer and containing 40 mass % or more of Au, or a region having a thickness of 3 nm or more from the uppermost surface toward the lower layer and containing 10 mass % or more to less than 40 mass % of Au.

### FIELD OF THE INVENTION

The present invention relates to a fuel cell separator material on which Au or an Au alloy (a layer containing Au) is formed, a fuel cell separator using the same, a fuel cell stack, and a method for producing the fuel cell separator material.

### DESCRIPTION OF THE RELATED ART

A polymer electrolyte fuel cell separator has electrical conductivity, connects each single cell electrically, collects energy (electricity) produced on each single cell, and has flow paths for fuel gas (fuel liquid) or air (oxygen) that are provided to each single cell. The separator is also referred to as an interconnector, a bipolar plate and a current collector.

Traditionally, as such a fuel cell separator, a carbon plate on which gas flow paths are formed has been used. However, it is undesirable in that material cost and processing cost are high. On the other hand, when a metal plate is used in place of the carbon plate, it might undesirably be corroded and eluted at high temperature under oxidizing atmosphere. To avoid this, there is a known technology that an alloy of Au and a noble metal selected from Au, Ru, Rh, Cr, Os, Ir, Pt or the like is sputtered on a stainless steel plate to form an electrical conductive portion (see Patent Literature 1).

On the other hand, it is known that a fuel cell separator is produced by forming an Au layer on an oxidized layer of a stainless steel base via an intermediate layer comprising Ti, Zr, Hf, V, Nb, Ta, Cr, Mo, W or the like (see Patent Literature 2). The intermediate layer is said to have good adhesion property with a base oxide layer, i.e., good binding property with O (oxygen atoms) and have good adhesion and binding properties with an Au layer, since the intermediate layer is metal or half-metal.

Further, there is a fuel cell metal separator that Au plating is applied to a surface of a stainless steel plate in an acidic bath with no base treatment (see Patent Literature 3).

As the polymer electrolyte fuel cell, a direct methanol fuel cell (DMFC) using methanol, which is easily handled, as a fuel gas to be fed to an anode has also been developed. Since the DMFC can take energy (electricity) directly from methanol, no reformer is needed, and a small-sized fuel cell can be produced, the DMFC is expected as a power supply of mobile devices.

Two structures of the DMFC are proposed: A first structure is a layered type (active type) structure that single cells (membrane electrode assemblies (herein referred to as MEAs) each of which is composed of a polymer electrolyte membrane sandwiched between a fuel electrode and an oxygen electrode) are layered. A second structure is a flat type (passive type) structure that a plurality of single cells are disposed in a planar direction. In these structures, a plurality of single cells are connected in series (herein referred to as a stack). Since the passive type structure requires no active fuel transport means for providing a fuel gas (fuel liquid) or air to the cell, the smaller-sized fuel cell may be expected.

There are many conditions required for the current collector of the DMFC as compared with those required for the polymer electrolyte fuel cell separator using hydrogen gas. Specifically, in addition to the corrosion resistance against a sulfuric acid solution required for the normal polymer electrolyte fuel cell, the corrosion resistance against a methanol fuel solution and a formic acid solution is required. The formic acid is a by-product produced when hydrogen ions are produced from methanol on an anode catalyst.

As described above, the materials that are used for the conventional polymer electrolyte fuel cell are not always applicable to the DMFC under the DMFC operable conditions.
[Patent Literature 1] Unexamined Japanese Patent Publication (Kokai) 2001-297777
[Patent Literature 2] Unexamined Japanese Patent Publication (Kokai) 2004-185998
[Patent Literature 3] Unexamined Japanese Patent Publication (Kokai) 2004-296381

### PROBLEMS TO BE SOLVED BY THE INVENTION

In the technology described in Patent Literature 1 mentioned above, to provide the Au alloy layer having good adhesion, the oxidized layer on the surface of the stainless steel base is required to be removed. If the oxidized layer is removed insufficiently, the adhesion of the noble metal layer is decreased.

As described in Patent Literature 2, the intermediate layer itself cannot provide the sufficient adhesion property, therefore, the conductivity and the corrosion resistance required for the fuel cell separator are not sufficiently achieved. In particular, it is insufficient to improve the corrosion resistance of the fuel cell under the operating environment.

On the other hand, according to the technology described in Patent Literature 3, wet gold plating is electrodeposited as granules such that the surface of the base may be partly non-plated when the amount of the gold plating is less. Accordingly, in order to gold-plate the whole surface of the base uniformly, the amount of Au should be increased.

Thus, the present invention is made to solve the problems described above. The object of the present invention is to provide a fuel cell separator material; a fuel cell separator using the same; a fuel cell stack, and a method for producing the fuel cell material that can form, on a surface of a stainless steel base, an electrically conductive layer containing Au having high corrosion resistance with high adhesion property.

### SUMMARY OF THE INVENTION

Through diligent studies, the present inventors found that an intermediate layer containing the predetermined metal and oxygen is formed on a surface of a stainless steel base, and an Au containing layer is formed on the intermediate layer, whereby the Au containing (alloy) layer can be formed on stainless steel base strongly and uniformly, and the conductivity and the corrosion resistance required for a fuel cell separator can be obtained.

To achieve the above object, the present invention provides a fuel cell separator material, comprising an alloy layer containing Au and a first component containing at least one or more metal selected from a group consisting of Al, Cr, Co, Ni, Cu, Mo, Sn and Bi or an Au single layer formed on a stainless steel base, or a region having a thickness of 3 nm or more from the uppermost surface toward the lower layer and containing 10 mass % or more to less than 40 mass % of Au, or an Au single layer, and an intermediate layer containing 20 mass % or more of the first component, and from 20 mass % or more to less than 50 mass % of O arranged between the alloy layer or the Au single layer and the stainless steel base, wherein the alloy layer or the Au single layer has a region having a thickness of 1 nm or more from the uppermost surface toward the lower layer and containing 40 mass % or more of Au, or the thickness of the Au single layer is 1 nm or more.

Preferably, the intermediate layer exists as a layer having a thickness of 1 nm or more.

Preferably, a metal layer containing 50 mass % or more of the first component having a thickness of 5 nm or less is formed or is not formed between the alloy layer and the intermediate layer.

Preferably, the concentration of the Au in the alloy layer is increased from the base to the surface.

Preferably, an Au single layer is formed on the uppermost surface of the alloy layer.

The fuel cell separator material of the present invention is preferably use in a polymer electrolyte fuel cell.

The fuel cell separator material of the present invention is preferably use in a direct methanol polymer electrolyte fuel cell.

A fuel cell separator of the present invention uses said fuel cell separator material, wherein a reaction gas flow path and/or a reaction liquid flow path is press-formed on the stainless steel base, and then the alloy layer or the Au single layer is formed.

A fuel cell separator of the present invention uses said fuel cell separator material, wherein the alloy layer or the Au single layer is formed on the stainless steel base, and then a reaction gas flow path and/or a reaction liquid flow path is press-formed.

A fuel cell stack of the present invention comprises the fuel cell separator material or the fuel cell separator.

A method for producing a fuel cell separator material of the present invention comprising coating the stainless steel base with the first component having a thickness of 1 nm or more by dry plating, and then coating with Au or an Au alloy having a thickness of 1 nm or more by dry plating.

Preferably, the dry plating is a sputter method.

According to the present invention, since an intermediate layer having the predetermined composition is formed on the surface of the stainless steel base, and the layer containing Au or the Au alloy layer is formed on the intermediate layer, the Au layer or the layer containing Au can be formed strongly and uniformly on the stainless steel base, and the conductivity and the corrosion resistance required for a fuel cell separator can be obtained.

### DESCRIPTION OF THE PREFERRED EMBODIMENTS

Embodiments of the fuel cell separator material according to the present invention will be described below. The symbol “%” herein refers to % by mass, unless otherwise specified.

The term “fuel cell separator” herein refers to a fuel cell separator which has electrical conductivity, connects each single cell electrically, collects energy (electricity) produced on each single cell, and has flow paths for fuel gas (fuel liquid) or air (oxygen) that is provided to each single cell. The separator is also referred to as an interconnector, a bipolar plate and a current collector.

Accordingly, the fuel cell separator includes a separator having concave-convex flow paths formed on a surface of a plate-like base, as well as a separator having flow paths with open holes for a gas or methanol formed on a surface of a plate-like base, such as the above-mentioned passive type DMFC separator.

Any polymer electrolyte fuel cell having a structure that a layer material consists of a polymer electrolyte is sandwiched between the electrodes may be used. Non-limiting fuel used includes hydrogen or methanol.

### First Embodiment

The fuel cell separator material according to the first embodiment of the present invention will be described below. As shown in FIG. 1, the fuel cell separator material according to the first embodiment comprises a stainless steel base 2, an intermediate layer 2a on the surface of the stainless steel base 2, a metal layer 4, and an alloy layer 6 over the intermediate layer 2a.

### <Stainless Steel Base>

The fuel cell separator material requires the corrosion resistance, and the alloy layer (Au single layer) to be the conductive layer requires the corrosion resistance and the conductivity. So, a stainless steel material having good corrosion resistance is used as the base.

Although the stainless steel base 2 is not especially limited as long as it is stainless steel, stainless steel having high corrosion resistance is preferable. Often, stainless steel having high corrosion resistance contains high concentration of Cr or Ni (ex. SUS316L). Also, although the shape of the stainless steel base 2 is not especially limited as long as the first component and Au can be sputtered. In terms of press-molding it to a separator shape, it is preferable that the stainless steel base is in a plate-like shape and the stainless steel base has a total thickness of 50 μm or more.

O (oxygen) contained in the intermediate layer 2a is naturally produced by leaving the stainless steel base 2 in the air, or leaving it in vacuum when a coating layer is formed on the surface of the stainless steel base 2 by sputtering. On the condition that O is contained in the range from 20 mass % or more to less than 50 mass %, O may be positively produced on the surface of the stainless steel base 2 under oxygen atmosphere.

### <Intermediate Layer>

Generally, in order to provide the fuel cell separator with the corrosion resistance, Au is formed on the metal base as the conductive layer. However, when the stainless steel is used as the base, the stainless oxide layer is formed on the surface of the stainless steel. The Au (containing) layer which is less oxidized is therefore difficult to be formed directly on the surface of the stainless steel base.

Hence, typically, the surface oxide layer of the stainless steel base is removed moderately, reverse sputtering (ion etching) may be conducted in order to clean the surface of the base. Especially, the stainless steel containing a high concentration of Cr has a thick surface oxide layer. It may require a time to remove the oxide layer or the oxide layer may not be sufficiently removed.

Accordingly, the Au layer is formed via the intermediate layer as described in Patent Literature 2 described above, thereby improving the adhesion property with the oxide layer of the base, i.e., the binding property with O (oxygen atom). However, it has been found that even though Ti, Zr, Hf, V, Nb, Ta, Cr, Mo or W is used for the intermediate layer, the fuel cell has poor corrosion resistance under its operating environment.

In view of the above, in the present invention, the intermediate layer 2a comprising a first component containing at least one or more metal selected from a group consisting of Al, Cr, Co, Ni, Cu, Mo, Sn and Bi and oxygen is formed on the surface of the stainless steel base 2, thereby successfully improving the adhesion between the stainless steel base 2 and the Au (alloy) layer 6.

The above-mentioned metals selected as the first component have properties including a) easy binding to oxygen, b) alloy formation with Au, and c) less absorption of hydrogen, and form the intermediate layer to improve the adhesion between the alloy layer and the stainless steel base. The first component may comprise a single element, may comprise a plurality of elements, but preferably comprises Cr in terms of the electrical conductivity, the corrosion resistance and the costs.

If the intermediate layer 2a does not contain 20 mass % or more of the first component, the adhesion with Au may be poor.

In addition, the intermediate layer 2a contains O in the range from 20 mass % or more to less than 50 mass %, resulting in good electrical conductivity and corrosion resistance under the operating conditions of the fuel cell. If the intermediate layer 2a contains less than 20 mass % of O, the corrosion resistance becomes poor, and the first component is eluted from the intermediate layer 2a to increase the contact resistance. On the other hand, if the intermediate layer 2a contains 50 mass % or more of O, the adhesion with Au is lowered to degrade the electrical conductivity.

As a method for controlling the concentration of O in the range from 20 mass % or more to less than 50 mass % in the intermediate layer, dry plating (sputtering) using a target comprising the first component is preferable. For example, upon sputtering, the sputter particles have great energy, whereby the layer having good adhesion property can be formed using the metal (the first component) that is bound to O without removing the oxide layer on the surface of the stainless steel. O that originally exists on the surface of the base and O that exists within the sputter chamber after vacuum evacuation bind to the first component (Cr or the like) formed by sputtering. Thus, the alloy layer or the Au single layer having good adhesion property, electrical conductivity and corrosion resistance can be obtained.

The first component less absorbs hydrogen such that no hydrogen embrittlement in the intermediate layer occurs even if hydrogen is used for generating electricity in the fuel cell.

It is preferable that the intermediate layer 2a has a thickness of 1 nm or more. In this case, when the section of the fuel cell separator material is analyzed by XPS (X-ray photoelectron spectroscopy), there exists the region having a thickness of 1 nm or more and containing 20% by mass or more of the first component and from 20% by mass or more to less than 50% by mass of O. The upper limit thickness of the intermediate layer having such composition is not limited, but is preferably 100 nm or less in terms of the costs of the first component.

In the XPS analysis, the region and the elements to be analyzed by the device are designated to detect the concentration of the designated elements in the region. The elements designated include Au, the first component, O, Fe, Cr, Ni and the like.

The distance 1 nm in the thickness direction refers to the real distance of the scanning distance in the XPS analysis.

### <Alloy Layer>

An alloy layer 6 containing a first component and Au is formed on the surface of the intermediate layer 2a. The alloy layer 6 is well adhered to the intermediate layer 2a, and, when the metal layer 4 (the single layer comprising the first component) is formed, makes the metal layer 4 thin to improve the corrosion resistance of the separator.

The alloy layer 6 can be obtained, for example, by sputtering the first component as the intermediate layer 2a, and then forming Au or the Au alloy. Thus, the Au alloy layer containing the first component and Au is formed on the intermediate layer.

The alloy layer 6 can be identified by the XPS analysis. According to the XPS analysis, the alloy layer is defined as the region having a thickness of 1 nm or more from the uppermost surface toward the lower layer and containing 40 mass % or more of Au disposed above the intermediate layer 2a. If the region having a thickness of 1 nm or more from the uppermost surface toward the lower layer contains less than 40 mass % of Au, the electrically conductivity and the corrosion resistance required for the fuel cell separator cannot be provided.

The alloy layer 6 preferably has a thickness of 1 to 100 nm. If the thickness of the alloy layer 6 is less than 1 nm, the corrosion resistance required for the fuel cell separator may not be provided. If the thickness of the alloy layer 6 exceeds 100 nm, the amount of gold is not saved, and the costs may be increased.

In addition, the first component and Au may be heat treated after the layer formation. When the heat treatment is conducted, oxidation and diffusion may proceed to decrease the concentration of Au on the surface layer to less than 40% by mass. However, when the region having a thickness of 3 nm or more from the uppermost surface toward the lower layer and containing 10% by mass or more to less than 40% by mass of Au exists, stainless material does not diffuse on the surface layer, and the alloy layer fulfills the function.

Also, the Au single layer may be formed on the surface of the alloy layer 6. The Au single layer includes 75% or more of Au by the XPS analysis.

### <Metal Layer>

The metal layer 4 is composed only of the first component(s). The intermediate layer is formed by diffusing a part of the first component to the stainless steel oxide layer, and the Au alloy layer is formed by diffusing a part of the first component to the surface. The first component, which is not diffused and remains, forms the metal layer 4. Accordingly, the metal layer 4 can be formed appropriately by changing the sputter conditions (sputter time, output and the like).

However, the metal layer 4 tends to decrease the corrosion resistance. Preferably, the metal layer 4 has a thickness of 5 nm or less, more preferably 3 nm or less. More preferably, no metal layer is provided as in second or third embodiment.

The metal in the metal layer 4 and the first component in the alloy layer 6 may be the same or different element. The use of the same element makes the manufacture easier.

The metal layer 4 can be identified by the XPS analysis. Based on the XPS analysis, the thickness of the metal layer 4 is defined when the total concentration of the first component is 50% by mass or more.

Preferably, the alloy layer has the gradient composition where the concentration of Au is increased from the bottom layer to the upper layer. The concentration (% by mass) of Au can be determined by the XPS analysis as described above. The thickness of the alloy layer or the Au single layer is the real distance of the scanning distance in the XPS analysis.

When the alloy layer has the gradient composition, the concentration of the first component that is easily oxidized than Au is increased in the bottom layer of the alloy layer, which is strongly bonded to the surface of the stainless steel base, and the properties of Au strongly affects on the upper layer of the alloy layer to improve the conductivity and the corrosion resistance.

### <Production of the Fuel Cell Separator Material>

The intermediate layer in the fuel cell separator material can be formed by sputtering the first component as the target to the base without removing the surface oxide layer on the stainless steel base, to bind the first component to O. Alternatively, the intermediate layer can also be formed by sputtering the oxide of the first component(s) as the target after the surface oxide layer of the stainless steel base 2 is removed, or by sputtering the first component as the target under oxidation atmosphere after the surface oxide layer of the stainless steel base 2 is removed.

Upon sputtering, the surface oxide layer on the stainless steel base may be properly removed and reverse sputtering (ion etching) may be conducted in order to clean the surface of the base. The reverse sputtering can be conducted by, for example, irradiating the base with argon gas at an argon pressure of about 0.2 Pa at RF output of about 100 W.

Au atoms may be incorporated into the intermediate layer by sputtering Au to form the alloy layer as described below. Alternatively, the alloy target containing the first component and Au may be sputtered to the surface of the stainless steel base.

### Second Embodiment

The fuel cell separator material according to the second embodiment of the present invention will be described below. As shown in FIG. 2, the fuel cell separator material according to the second embodiment comprises an intermediate 2a formed on a surface of a stainless steel base 2, and an alloy layer 6 formed on the intermediate layer 2a.

Since the stainless steel base 2 and the alloy layer 6 are the same as the first embodiment, a description is omitted. The fuel cell separator material according to the second embodiment is different from the first embodiment in that no metal layer 4 is formed, and has excellent corrosion resistance as compared with the first embodiment.

In the second embodiment, no metal layer 4 exists, and the concentration of O at the surface side of the intermediate layer 2a is therefore high. Even if an attempt that Au is formed on such an intermediate layer 2a to form the alloy layer (or the Au single layer) is made, sufficient adhesion property may not be provided. If Au can be formed on the intermediate layer 2a, Au may be diffused into the intermediate layer such that the intermediate layer thickens, but the alloy layer cannot have sufficient thickness, whereby the alloy layer 6 may have the decreased corrosion resistance.

In view of the above, it is preferable that the depth region having the Au concentration of 30 mass % has the O concentration of 40 mass % or less. The above-mentioned region is generally contained in the intermediate layer, but, if the metal layer 4 exists, the layer to which the above-mentioned region belongs may be changed, so the area is defined as the “region”. The region shows near a boundary between the intermediate layer (or the metal layer) and the alloy layer, has the decreased O concentration at the boundary with the alloy layer, and hardly degrades the adhesion property and electrical conductivity of the metal layer 6. For example, in the second embodiment, the above-mentioned region is near the surface of the intermediate layer 2a, has the decreased O concentration on the surface of the intermediate layer 2a at the boundary with the alloy layer 6, and advantageously hardly degrades the adhesion property and electrical conductivity of the metal layer 6.

Also in the second embodiment as in the first embodiment, the alloy layer preferably has a thickness of 1 to 100 nm.

### Third Embodiment

The fuel cell separator material according to the third embodiment of the present invention will be described below. As shown in FIG. 3, the fuel cell separator material according to the third embodiment comprises an alloy layer 6 formed on a surface of a stainless steel base 2 via an intermediate layer 2a, and an Au single layer 8 is formed on the surface of the alloy layer 6. Since the stainless steel base 2 and the alloy layer 6 are the same as the first embodiment, a description is omitted.

The Au single layer 8 can be formed appropriately by changing the sputter conditions (sputter time, output and the like).

Alternatively, the layer structures of the first and third embodiments may be combined to form a layer structure having the metal layer 4, the alloy layer 6 and the Au single layer 8 in order via the intermediate layer 2a on the surface of the stainless base 2.

According to the fuel cell separator material embodiments of the present invention, the Au (alloy) layer can be formed on the stainless steel strongly and uniformly and this layer has conductivity, corrosion resistance and durability, which is suitable to a fuel cell separator material. In addition, according to the embodiments of the present invention, the Au (alloy) layer is sputtered to be uniform, which is smoother than that formed by Au wet plating, so Au is advantageously saved. Further, since O exists in the intermediate layer, the corrosion resistance can be advantageously improved.

In the fuel cell separator of the present invention, reaction gas flow paths and/or reaction liquid flow paths are preferably press-formed on the stainless steel base in advance. In this way, there is no need to form the reaction gas flow paths (reaction liquid flow paths) in the later process, the stainless steel base is press-formed before the intermediate layer, the alloy layer and the like are formed, whereby the reaction flow paths (reaction liquid flow paths) are easily formed. Thus, the productivity is improved.

In the fuel cell separator of the present invention, on the fuel cell separator material comprising the alloy layer or the Au single layer formed on the surface of the stainless steel base, the reaction gas flow paths and/or the reaction liquid flow paths may be press-formed later. According to the fuel cell separator material of the present invention, since the alloy layer or the Au single layer strongly adheres to the surface of the stainless steel base, the reaction gas flow paths (reaction liquid flow paths) can be press-formed even after the layer formation without delaminating the layer. Thus, the productivity is improved.

In order to press-form the reactive gas flow paths (reaction liquid flow paths), it is preferable that the stainless steel base of the fuel cell separator material has a thickness of 50 μm or more. The upper limit of the thickness of the stainless steel base is not limited, but it is preferably 200 μm or less in terms of the costs.

### <Fuel Cell Stack>

The fuel cell stack of the present invention is obtained by using the fuel cell separator material of the present invention or the fuel cell separator of the present invention.

### EXAMPLES

### Sample Preparation

A stainless steel material (SUS316L) having a thickness of 100 μm was used as the stainless steel base.

A Cr layer (metal layer) was formed on the surface of the stainless steel oxide layer of the stainless steel base using a sputtering method to have the predetermined target thickness. Upon sputtering, reverse sputtering (ion etching) may be conducted in order to clean the surface of the base. A Cr target was used. Then, an Au layer was formed thereon using the sputtering method to have the predetermined target thickness. Thus, the samples in Examples 1 to 12 were prepared. An Au target was used.

As Comparative Examples 12, 13 and 14, only the Au layer or only the Cr layer was formed upon sputtering, respectively.

As Comparative Example 15, the Cr layer was formed upon sputtering such that the target thickness was decreased to 0.5 nm. As Comparative Example 16, the Au layer was formed upon sputtering such that the target thickness was decreased to 2 nm.

The target thickness was determined as follows: the object (e.g. Cr) was formed on a copper foil material by sputtering. The actual thickness was measured by a fluorescent X-ray layer thickness meter (SEA5100 manufactured by Seiko Instruments, collimator 0.1 mm phi (diameter)), and the sputter rate (nm/min) under this sputtering condition was determined. Based on the sputter rate, the sputtering time for providing the thickness of 1 nm was calculated, and the sputtering was performed under this condition. The reason why copper was used as the base for determining the target thickness is that Cr exists in the base, when the base is stainless steel, and the amount of Cr cannot be determined accurately. Cr and Au were sputtered using the sputtering apparatus manufactured by ULVAC-PHI, Inc., under the following conditions: output of DC50W, and argon pressure of 0.2 Pa.

### <Measurement of Layer Structure>

The concentrations of Au, the first component (Cr in these Examples), O, Fe and Ni of the resultant sample were analyzed by a depth profile of the XPS analysis to determine the layer structure. As the XPS, 5600MC manufactured by ULVAC-PHI, Inc., was used at ultimate vacuum of 6.5×10⁻⁸ Pa, excitation source of monochromatic AIK, output of 300 W, detected area of 800 μm diameter, incident angle of 45 degree, take-off angle of 45 degree without a electron flood gun under the following sputtering conditions:

Ion species: Ar+

Acceleration voltage: 3 kV

Sweep area: 3 mm×3 mm

Rate: 3.7 nm/min (SiO₂ conversion)

The concentration (% by mass) of each element was analyzed using the XPS based on the total 100% by mass of the designated element. The term “1 nm distance” in the thickness direction in the XPS analysis refers to the abscissa axis distance (distance by SiO₂ conversion) of the chart of the XPS analysis.

FIG. 4 shows the XPS image of the section of the sample in Example 6.

It turns out that the intermediate layer 2a comprising 20% by mass or more of Cr and from 20% by mass or more to less than 50% by mass of O is provided on the surface of the stainless steel base 2. It also turns out that there is provided the alloy layer 6 comprising 40% by mass or more of Au with a thickness of 1 nm or more from the uppermost surface toward the lower layer.

FIG. 5 shows the XPS image of the section of the sample in Example 12. Example 12 is different from other Examples in that the sample was prepared by heating at 160° C. for 24.6 hours after the Au layer and the Cr layer were formed. The condition of 160° C. for 24.6 hours is assumed that the fuel cell is used for 400,000 hours (about 40 years). As shown in FIG. 5, the region (corresponding to the intermediate layer) containing from 10 mass % or more to less than 40% by mass of Au is formed at a thickness of 3 nm or more.

### <Evaluation>

Each sample was evaluated as follows:

### A. Adhesion Property

The uppermost alloy layer of each sample was scribed a grid pattern at 1 mm intervals. The adhesion tape was adhered thereto. Each sample piece was bent at 180 degree and was then returned to the original position. The tape on the bent portion was rapidly and strongly peeled off. Thus, the peeling test was performed.

When no peeling-off occurred, the evaluation was good. When any peeling-off was recognized by visual inspection, the evaluation was bad.

### B. Contact Resistance and Corrosion Resistance

Contact resistance was measured by applying a load onto the entire surface of the sample. A carbon paper was laminated on one side of a 40×50 mm sheet sample. Cu/Ni/Au plates were laminated on another side of the sample and on the carbon paper. The Cu/Ni/Au plate was a material comprising a copper plate having a thickness of 10 mm, Ni base plating having a thickness of 10 μm on the copper plate, and Au plating having a thickness of 0.5 μm on the Ni layer. The surface of the Au plating of the Cu/Ni/Au plate was disposed to be contacted with the sample or the carbon paper.

On the outer surface of the Cu/Ni/Au plate, a TEFLON™ plate was disposed. To the outside of the TEFLON™ plate, a load of 10 kg/cm² was applied by a load cell in a compression direction. Under the condition, a constant current having a current density of 100 mA/cm² was applied between two Cu/Ni/Au plates to measure electric resistance therebetween by four terminal method.

Contact resistance was measured before and after the corrosion test that the sample was immersed into the solution under the following four conditions:

Condition 1: Sulfuric acid solution (bath temperature of 80° C., concentration of 0.5 g/L, immersion time of 240 hours)
Condition 2: Methanol solution (bath temperature of 80° C., concentration of 400 g/L, immersion time of 240 hours)
Condition 3: Formic acid solution A (bath temperature of 80° C., concentration of 1 g/L, immersion time of 240 hours)
Condition 4: Formic acid solution B (bath temperature of 80° C., concentration of 9 g/L, immersion time of 240 hours)

In the case of the DMFC, the conditions 2 to 4 are added to the condition 1 (the corrosion condition of the normal polymer electrolyte fuel cell), and the numbers of the corrosion test conditions to be evaluated are increased as compared with the normal polymer electrolyte fuel cell.

Typical properties needed for the fuel cell separators are low contact resistance (10 mΩ·cm² or less) and corrosion resistance under the usage environment (low contact resistance and no toxic ion elution (<=0.1 mg/L)) after the corrosion test.) The ion elution was analyzed by ICP.

Tables 1 to 3 show the results. The thickness of each of the intermediate layer, the uppermost layer and the metal layer was an average value of three points by the XPS analysis.

TABLE 1

| | | | | | | | | Thickness | Thickness | |
|---|---|---|---|---|---|---|---|---|---|---|
| | | | | | | | | of | of a | |
| | | | | | | | | 40 wt % | region of | |
| | | | | | Heat | | | or more | 10 wt % or | |
| | | | | | treatment | | | of Au | more of Au | |
| | | | | | after layer | | Inter- | from the | from the | |
| | | | | | forma- | | mediate | uppermost | uppermost | Metal |
| | | Type of | | | tion(160 | | layer | to | to | layer |
| | | stainless | Layer | | degree C. × | Adhesion | thickness | the lower | the lower | thickness |
| | No. | steel base | forming | Layer forming method | 24.6 h) | property | [nm] | layer[nm] | layer[nm] | [nm] |
| Example | 1 | SUS316L | Sputtering | 1 nm thickness Cr layer was | No | Good | 1 | 1.0 | — | 0 |
| | | | | formed, then 3 nm thickness | | | | | | |
| | | | | Au layer was formed. | | | | | | |
| | 2 | SUS316L | Sputtering | 1 nm thickness Cr layer was | No | Good | 1 | 2.0 | — | 0 |
| | | | | formed, then 5 nm thickness | | | | | | |
| | | | | Au layer was formed. | | | | | | |
| | 3 | SUS316L | Sputtering | 1 nm thickness Cr layer was | No | Good | 1 | 5.0 | — | 0 |
| | | | | formed, then 10 nm thickness | | | | | | |
| | | | | Au layer was formed. | | | | | | |
| | 4 | SUS316L | Sputtering | 2 nm thickness Cr layer was | No | Good | 2 | 2.5 | — | 0 |
| | | | | formed, then 5 nm thickness | | | | | | |
| | | | | Au layer was formed. | | | | | | |
| | 5 | SUS316L | Sputtering | 2 nm thickness Cr layer was | No | Good | 2 | 5.0 | — | 0 |
| | | | | formed, then 10 nm thickness | | | | | | |
| | | | | Au layer was formed. | | | | | | |
| | 6 | SUS316L | Sputtering | 5 nm thickness Cr layer was | No | Good | 5 | 2.5 | — | 0 |
| | | | | formed, then 5 nm thickness | | | | | | |
| | | | | Au layer was formed. | | | | | | |
| | 7 | SUS316L | Sputtering | 5 nm thickness Cr layer was | No | Good | 5 | 5.0 | — | 0 |
| | | | | formed, then 10 nm thickness | | | | | | |
| | | | | Au layer was formed. | | | | | | |
| | 8 | SUS316L | Sputtering | 7 nm thickness Cr layer was | No | Good | 7 | 5.0 | — | 2 |
| | | | | formed, then 10 nm thickness | | | | | | |
| | | | | Au layer was formed. | | | | | | |
| | 9 | SUS316L | Sputtering | 10 nm thickness Cr layer was | No | Good | 10 | 5.0 | — | 5 |
| | | | | formed, then 10 nm thickness | | | | | | |
| | | | | Au layer was formed. | | | | | | |
| | 10 | SUS316L | Sputtering | 15 nm thickness Cr layer was | No | Good | 13 | 5.0 | — | 8 |
| | | | | formed, then 10 nm thickness | | | | | | |
| | | | | Au layer was formed. | | | | | | |
| | 11 | SUS316L | Sputtering | 2 nm thickness Cr layer was | No | Good | 2 | 1.5 | — | 0 |
| | | | | formed, then 3 nm thickness | | | | | | |
| | | | | Au layer was formed. | | | | | | |
| | 12 | SUS316L | Sputtering | 2 nm thickness Cr layer was | Done | Good | 9 | — | 4.5 | 0 |
| | | | | formed, then 3 nm thickness | | | | | | |
| | | | | Au layer was formed. | | | | | | |
| Comp. | 20 | SUS316L | Sputtering | Only 10 nm thickness | No | Bad | 0 | 11.0 | — | 0 |
| Ex | | | | Au layer was formed. | | | | | | |
| | 21 | SUS316L | Sputtering | Only 10 nm thickness | No | Good | 11 | 0 | — | 12 |
| | | | | Cr layer was formed. | | | | | | |
| | 22 | SUS316L | Sputtering | 0.5 nm thickness Cr layer was | No | Bad | less than 1 | 3.0 | — | 0 |
| | | | | formed, then 5 nm thickness | | | | | | |
| | | | | Au layer was formed. | | | | | | |
| | 23 | SUS316L | Sputtering | 1 nm thickness Cr layer was | No | Good | 1.5 | less than 1 | — | 0 |
| | | | | formed, then 2 nm thickness | | | | | | |
| | | | | Au layer was formed. | | | | | | |

TABLE 2

| | | Contact resistance [mΩ · cm²] | | | | | | | |
|---|---|---|---|---|---|---|---|---|---|
| | | Sulfuric acid solution | | Methanol solution | | Formic acid solution A | | Formic acid solution B | |
| | | Before the | After the | Before the | After the | Before the | After the | Before the | After the |
| | No | corrosion test | corrosion test | corrosion test | corrosion test | corrosion test | corrosion test | corrosion test | corrosion test |
| Example | 1 | 10 | 10 | 10 | 10 | 10 | 10 | 10 | 10 |
| | 2 | 10 | 10 | 10 | 10 | 10 | 10 | 10 | 10 |
| | 3 | 10 | 10 | 10 | 10 | 10 | 10 | 10 | 10 |
| | 4 | 10 | 10 | 10 | 10 | 10 | 10 | 10 | 10 |
| | 5 | 10 | 10 | 10 | 10 | 10 | 10 | 10 | 10 |
| | 6 | 10 | 10 | 10 | 10 | 10 | 10 | 10 | 10 |
| | 7 | 10 | 10 | 10 | 10 | 10 | 10 | 10 | 10 |
| | 8 | 10 | 10 | 10 | 10 | 10 | 10 | 10 | 10 |
| | 9 | 10 | 10 | 10 | 10 | 10 | 10 | 10 | 10 |
| | 10 | 10 | 10 | 10 | 10 | 10 | 10 | 10 | 10 |
| | 11 | 10 | 10 | 10 | 10 | 10 | 10 | 10 | 10 |
| | 12 | 10 | 10 | 10 | 10 | 10 | 10 | 10 | 10 |
| Comp. | 20 | — | — | — | — | — | — | — | — |
| Ex | 21 | 10 | 40 | 10 | 13 | 10 | 20 | 10 | 30 |
| | 22 | — | — | — | — | — | — | — | — |
| | 23 | 10 | 42 | 10 | 18 | 10 | 28 | 10 | 47 |

| | | | | | | | | |
|---|---|---|---|---|---|---|---|---|
| Target value | 10 | 10 | 10 | 10 | 10 | 10 | 10 | 10 |

TABLE 3

| | | Metal elution amount after the corrosion test [mg/L] | |
|---|---|---|---|
| | No. | Sulfuric acid solution | Formic acid solution B |
| Example | 1 | <0.01 | <0.01 |
| | 2 | <0.01 | <0.01 |
| | 3 | <0.01 | <0.01 |
| | 4 | <0.01 | <0.01 |
| | 5 | <0.01 | <0.01 |
| | 6 | <0.01 | <0.01 |
| | 7 | <0.01 | <0.01 |
| | 8 | 0.02 | 0.01 |
| | 9 | 0.03 | 0.03 |
| | 10 | 0.06 | 0.05 |
| | 11 | <0.01 | <0.01 |
| | 12 | <0.01 | <0.01 |
| Comparative | 20 | — | — |
| Example | 21 | 0.43 | 0.38 |
| | 22 | — | — |
| | 23 | <0.01 | <0.01 |

| | | |
|---|---|---|
| Target | <=0.1 | <=0.1 |

As shown in Tables 1 to 3, in Examples 1 to 12 having the intermediate layer containing 20% by mass or more of Cr (the first component) and from 20% by mass or more to less than 50% by mass of O between the alloy layer and the stainless steel base, the alloy layer containing 40% by mass or more of Au with a thickness of 1 nm or more from the uppermost surface toward the lower layer, or the region containing from 10% by mass or more to less than 40% by mass of Au from the uppermost surface toward the lower layer with a thickness of 3 nm or more, all layers had excellent adhesion, the contact resistance did not change before and after the corrosion test, less metal was eluted, and the electrical conductivity and the durability were excellent.

In Example 10, the metal layer had a thickness of exceeding 5 nm, the metal elution amount after the corrosion test was slightly higher than those in other Examples, but there is no problem in practical use.

In Comparative Example 20 where only Au was sputtered, no intermediate layer was formed and the adhesion property became poor. On the other hand, in Comparative Example 21 where only Cr was sputtered and the uppermost layer did not contain Au, the contact resistance was significantly increased after the corrosion test. It is considered that the corrosion resistance was decreased because the uppermost layer did not contain Au.

In Comparative Example 22 where the target thickness of the Cr layer was decreased to 0.5 nm and the intermediate layer was sputtered, the intermediate layer had a thickness of less than 1 nm, and the adhesion property became poor.

In Comparative Example 23 where the target thickness of the Au layer was decreased to 2 nm, the region containing 40% by mass or more of Au from the uppermost surface toward the lower layer had a thickness of less than 1 nm, the contact resistance was significantly increased after the corrosion test.

### BRIEF DESCRIPTION OF THE DRAWING

FIG. 1 shows a structure of a fuel cell separator material according to the first embodiment of the present invention;

FIG. 2 shows a structure of a fuel cell separator material according to the second embodiment of the present invention;

FIG. 3 shows a structure of a fuel cell separator material according to the third embodiment of the present invention;

FIG. 4 is an XPS analysis of the fuel cell separator material according to Example 6; and

FIG. 5 shows an XPS analysis of the fuel cell separator material according to Example 12.

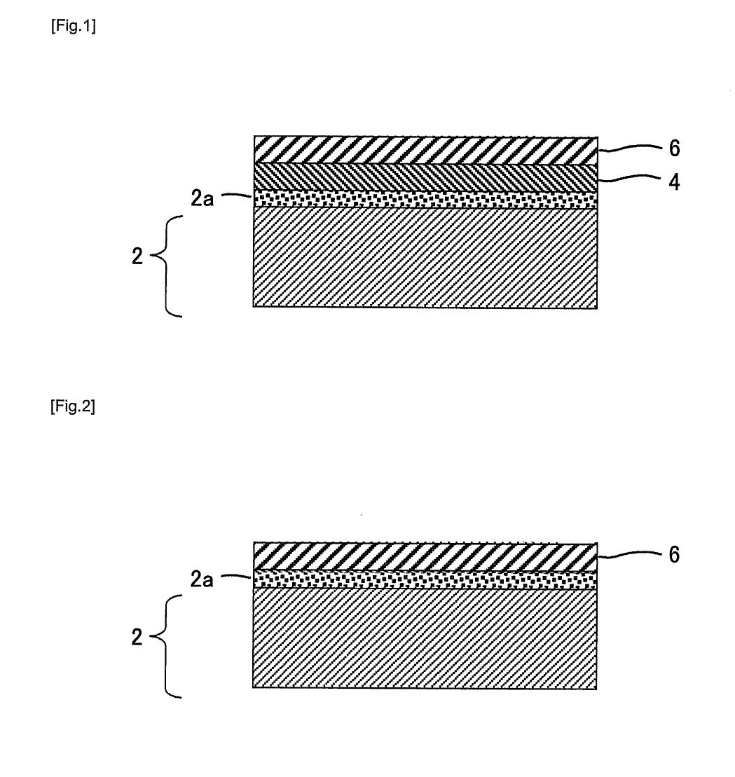

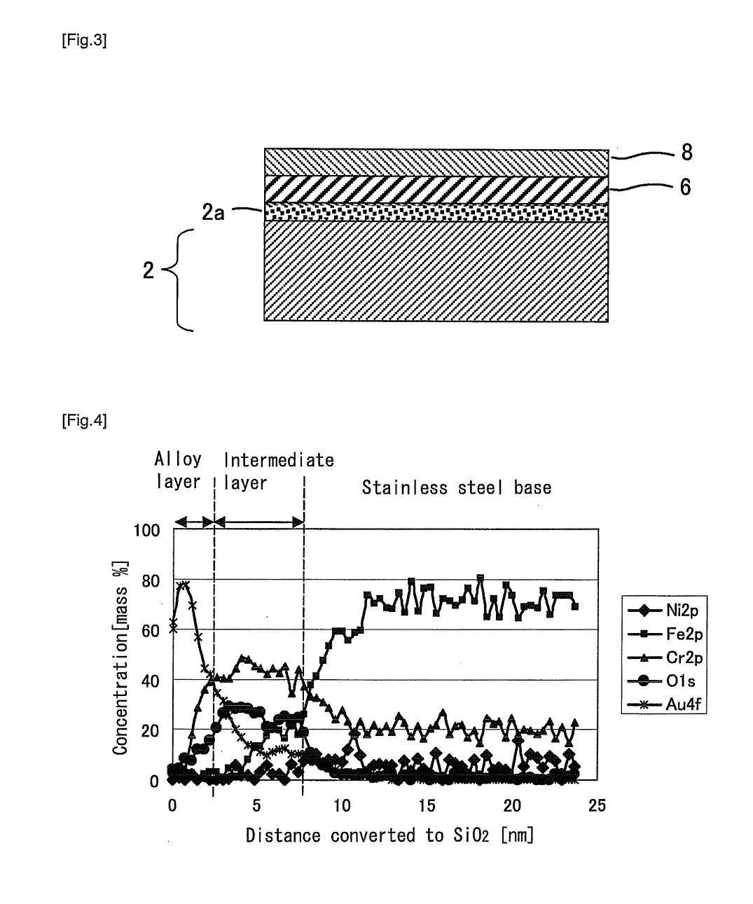

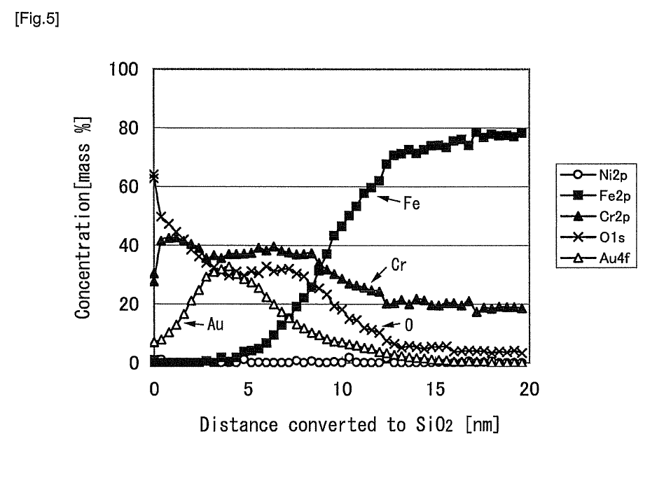

### DESCRIPTION OF THE NOTE

2 stainless steel base
2a intermediate layer
4 metal layer (a single layer comprising the first component)
6 alloy layer
8 Au single layer

1. A fuel cell separator material, comprising an alloy layer containing Au and a first component containing at least one or more metal selected from a group consisting of Al, Cr, Co, Ni, Cu, Mo, Sn and Bi or an Au single layer formed on a stainless steel base, and an intermediate layer containing 20 mass % or more of the first component, and from 20 mass % or more to less than 50 mass % of O arranged between the alloy layer or the Au single layer and the stainless steel base, wherein the alloy layer or the Au single layer has a region having a thickness of 1 nm or more from the uppermost surface toward the lower layer and containing 40 mass % or more of Au, or a region having a thickness of 3 nm or more from the uppermost surface toward the lower layer and containing 10 mass % or more to less than 40 mass % of Au, or the thickness of the Au single layer is 1 nm or more.

2. The fuel cell separator material according to claim 1, wherein the intermediate layer exists as a layer having a thickness of 1 nm or more.

3. The fuel cell separator material according to claim 1, wherein a metal layer containing 50 mass % or more of the first component having a thickness of 5 nm or less is formed or is not formed between the alloy layer and the intermediate layer.

4. The fuel cell separator material according to claim 2, wherein a metal layer containing 50 mass % or more of the first component having a thickness of 5 nm or less is formed or is not formed between the alloy layer and the intermediate layer.

5. The fuel cell separator material according to claim 1, wherein the concentration of the Au in the alloy layer is increased from the base to the surface.

6. The fuel cell separator material according to claim 2, wherein the concentration of the Au in the alloy layer is increased from the base to the surface.

7. The fuel cell separator material according to claim 3, for wherein the concentration of the Au in the alloy layer is increased from the base to the surface.

8. The fuel cell separator material according to claim 7, wherein an Au single layer is formed on the uppermost surface of the alloy layer.

9. The fuel cell separator material according to claim 1, for use in a polymer electrolyte fuel cell.

10. The fuel cell separator material according to claim 9, for use in a direct methanol polymer electrolyte fuel cell.

11. A fuel cell separator using the fuel cell separator material according to claim 1, wherein a reaction gas flow path and/or a reaction liquid flow path is press-formed on the stainless steel base, and then the alloy layer or the Au single layer is formed.

12. A fuel cell separator using the fuel cell separator material according to claim 1, wherein the alloy layer or the Au single layer is formed on the stainless steel base, and then a reaction gas flow path and/or a reaction liquid flow path is press-formed method.

13. A fuel cell stack, comprising the fuel cell separator material according to claim 1.

14. A fuel cell stack, comprising the fuel cell separator according to claim 11.

15. A fuel cell stack, comprising the fuel cell separator according to claim 12.

16. A method for producing a fuel cell separator material according to claim 1, comprising coating the stainless steel base with the first component having a thickness of 1 nm or more by dry plating, and then coating with Au or an Au alloy having a thickness of 1 nm or more by dry plating.

17. A method for producing a fuel cell separator material according to claim 16, wherein the dry plating is a sputter method.
